(19) United States
(12) Patent Application Publication
(10) Pub. No.: US 2023/0228884 A1
(43) Pub. Date: Jul. 20, 2023

(54) STATIONARY OBSTACLE DETECTION METHOD FOR VEHICLE BY SENSOR FUSION TECHNOLOGY, AND OBSTACLE DETECTION SYSTEM AND DRIVING SYSTEM FOR VEHICLE USING THE SAME

(71) Applicants: HYUNDAI MOTOR COMPANY, Seoul (KR); KIA CORPORATION, Seoul (KR)

(72) Inventor: Sang Bok Won, Hwaseong-si (KR)

(73) Assignees: HYUNDAI MOTOR COMPANY, Seoul (KR); KIA CORPORATION, Seoul (KR)

(21) Appl. No.: 17/941,221

(22) Filed: Sep. 9, 2022

(30) Foreign Application Priority Data
Jan. 14, 2022 (KR) 10-2022-0005795

(51) Int. Cl. G01S 17/931; B60W 30/09

(52) U.S. Cl. CPC G01S 17/931; B60W 30/09; B60W 2420/42; B60W 2420/52

(57) ABSTRACT

A stationary obstacle detection method for a vehicle, includes collecting LiDAR data on a surrounding area, collecting at least one of non-LiDAR data from camera data and radar data on the surrounding area, extracting a stationary obstacle candidate from the LiDAR data, extracting matching data to be matched with the extracted stationary obstacle candidate from the non-LiDAR data, and performing evaluation and determination in which matchability between the LiDAR data and the matching data on the extracted stationary obstacle candidate is evaluated on a variable grid to determine whether the extracted stationary obstacle candidate is a stationary obstacle.

The present application claims priority to Korean Patent Application No. 10-2022-0005795, filed on Jan. 14, 2022, the entire contents of which is incorporated herein for all purposes by this reference.

### BACKGROUND OF THE PRESENT DISCLOSURE

### Field of the Present Disclosure

The present disclosure relates to a stationary obstacle detection method for a vehicle by sensor fusion technology, and an obstacle detection system and a driving system for a vehicle using the method.

### Description of Related Art

First, “driving system”, as used herein, includes a system mounted in an object to drive such as a vehicle to assist a driver in driving the vehicle or to execute automated driving. In other words, the driving system includes an advanced driver-assistance system (ADAS) and an automated driving system.

Such a driving system detects obstacles around the vehicle using various sensors such as a Light Detection and Ranging (LiDAR) sensor, a camera, and a radar, and with the advancement of autonomous driving technology, the accuracy in detecting obstacles becomes increasingly important.

Although some companies, such as Tesla, are somewhat skeptical of LiDAR, because LiDAR recognizes atypical objects better than other sensors, the view of LiDAR as an essential technology for autonomous driving is dominant, and the development of LiDAR technology becomes more and more active.

LiDAR emits light and receives reflected light to detect an object and measure the distance thereto. LiDAR is similar to radar (radio detection and ranging) in function, but different in that LiDAR utilizes light. Furthermore, LiDAR is superior to radar in azimuth resolution, distance resolution, and the like.

Technology to detect obstacles around a vehicle using such a LiDAR sensor has been developed a long time ago and has also been used in autonomous driving demonstration vehicles.

For example, it is generally known that object cells and background cells are distinguished from each other on a grid map of LiDAR data, a road fixture such as an overpass and a signpost among the object cells is distinguished from the other objects, and vehicles and people are distinguished by clustering the object cells.

However, there is a problem in that LiDAR has a poor ability in detecting the type and speed of an object, incorrectly recognizing a preceding vehicle as a stationary obstacle.

In FIG. 1A, a situation in which a first preceding vehicle is traveling on the left, and directly in front of a host vehicle, a second preceding vehicle is traveling on the right, and a third preceding vehicle is traveling in front of the first and second preceding vehicles is taken as an example.

In the present situation, when obstacles are detected by LiDAR, as illustrated in FIG. 1B, the first preceding vehicle and the second preceding vehicle are properly detected as vehicles traveling in front of the host vehicle. However, because the third preceding vehicle is partially exposed between the first and the second preceding vehicles, and only a portion thereof is located within a LiDAR sensing area, it is difficult to completely obtain LiDAR data on the third preceding vehicle. For the present reason, from the LiDAR data on the third preceding vehicle, the third preceding vehicle may not be detected as a vehicle traveling in front of the host vehicle, but may be mistakenly recognized as a stationary obstacle.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a stationary obstacle detection method for a vehicle by sensor fusion technology, and an obstacle detection system and a driving system for a vehicle using the method that substantially obviate one or more problems due to limitations and disadvantages of the related art.

Various aspects of the present disclosure are directed to providing an exemplary embodiment that aims to solve at least one of the problems in the related art described above.

The, the present disclosure aims to increase the reliability in detecting a stationary obstacle by LiDAR using sensor fusion technology.

Additional advantages, objects, and features of the present disclosure will be set forth in part in the description which follows and in part will become apparent to those having ordinary skill in the art upon examination of the following or may be learned from practice of the present disclosure. The objectives and other advantages of the present disclosure may be realized and attained by the structure pointed out in the written description and claims hereof as well as the appended drawings.

To achieve these objects and other advantages and in accordance with the present disclosure, as embodied and broadly described herein, there is provided a stationary obstacle detection method for a vehicle, the method including collecting LiDAR data on a surrounding area, collecting at least one of non-LiDAR data from camera data and radar data on the surrounding area, extracting a stationary obstacle candidate from the LiDAR data, extracting matching data to be matched with the extracted stationary obstacle candidate from the non-LiDAR data, and performing evaluation and determination in which matchability between the LiDAR data and the matching data on the extracted stationary obstacle candidate is evaluated on a variable grid to determine whether the extracted stationary obstacle candidate is a stationary obstacle.

The performing evaluation and determination may include generating the variable grid corresponding to the LiDAR data on the extracted stationary obstacle candidate and setting a matching data area corresponding to the matching data on the variable grid, and determining an evaluation value according to an overlap between a variable grid area and the matching data area.

Here, the matching data area may be obtained by mapping the matching data on the variable grid.

Furthermore, the overlap may be determined by the ratio of the number of cells overlapping the matching data area to the total number of cells in the variable grid area.

The variable grid may be divided into a constant number of cells regardless of the sizes of the stationary obstacle candidate and the matching data.

Here, the variable grid may have a rectangular shape, and the cells may be divided into m cells in the horizontal direction and n cells in the longitudinal direction in the variable grid area, wherein the m and the n are integers greater than zero.

The variable grid may be determined by the maximum and minimum values in the horizontal direction and the maximum and minimum values in the longitudinal direction in the LiDAR data on the extracted stationary obstacle candidate.

The matching data may include at least one of camera data on a moving object, radar data on the moving object, and radar data on a stationary object.

Here, the evaluation value may be determined according to at least one of a first evaluation value determined from a first overlap between an area corresponding to the camera data on the moving object and the variable grid area, a second evaluation value determined from a second overlap between an area corresponding to the radar data on the moving object and the variable grid area, a third evaluation value determined from a third overlap between an area corresponding to the radar data on the stationary object and the variable grid area, and a fourth evaluation value for the LiDAR data on the extracted stationary obstacle candidate itself.

The evaluation value may be determined by adding a weight factor to each of the first evaluation value, the second evaluation value, the third evaluation value, and the fourth evaluation value.

The area corresponding to the camera data on the moving object may be adjusted in size in consideration of the location of a camera.

Here, the first evaluation value may be set smaller as the first overlap increases.

Furthermore, the second evaluation value may be set smaller as the second overlap increases.

Also, the third evaluation value may be set smaller as the third overlap increases.

In another aspect of the present disclosure, a stationary obstacle detection system includes a LiDAR sensor configured to obtain LiDAR data on a surrounding area, a non-LiDAR sensor configured to collect at least one of non-LiDAR data from camera data and radar data on the surrounding area, and an evaluation determination unit configured to extract a stationary obstacle candidate from the LiDAR data, extract matching data to be matched with the extracted stationary obstacle candidate from the non-LiDAR data, and determine whether the extracted stationary obstacle candidate is a stationary obstacle by evaluating matchability between the LiDAR data and the matching data on the extracted stationary obstacle candidate on a variable grid.

In another aspect of the present disclosure, a vehicle driving system includes the stationary obstacle detection system described above, and a vehicle control unit configured to output a control signal for a brake and/or a steering wheel according to the determination of the evaluation determination unit.

It is to be understood that the foregoing general description and the following detailed description of the present disclosure are exemplary and explanatory and are intended to provide further explanation of the present disclosure as claimed.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

The accompanying drawings, which are included to provide a further understanding of the present disclosure and are incorporated in and form a part of the present application, illustrate embodiment(s) of the present disclosure without being limited thereto and together with the description serve to explain the principle of the present disclosure.

FIG. 1A and FIG. 1B are examples of detecting obstacles in the front by a LiDAR;

FIG. 2 is a flowchart of an obstacle detection method according to various exemplary embodiments of the present disclosure;

FIG. 3 is an example of evaluating the matchability between LiDAR data and camera data;

FIG. 4 is an example of a variable grid area and divided cells of LiDAR data for a small object;

FIG. 5 is an example of a variable grid area and divided cells of LiDAR data for a large object;

FIG. 6 is an example of evaluating the matchability between LiDAR data and radar data for a moving object;

FIG. 7 is an example of evaluating the matchability between LiDAR data and radar data for a stationary object; and

FIG. 8 is an example of a stationary obstacle detection system and a driving system according to various exemplary embodiments of the present disclosure.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes will be determined in part by the particularly intended application and use environment.

In the figures, reference numbers refer to the same or equivalent parts of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, various embodiments of the present disclosure will be described in detail with reference to the accompanying drawings, the same reference numerals are used to designate the same/like components, and a redundant description thereof will be omitted.

In general, a suffix such as “unit” may be used to refer to elements or components. Use of such a suffix herein is merely intended to facilitate description of the specification, and the suffix itself is not intended to give any special meaning or function. Exemplarily, “oo portion” may be a component that performs a function different from that of “xx portion”. However, in an exemplary embodiment of the present disclosure, the functions may be implemented in parallel or sequentially in one microprocessor without being physically divided or separated, and the suffix “portion” does not exclude the present meaning. The same applies to the suffix “module”.

In describing the present disclosure, if a detailed explanation of a related known function or construction is considered to unnecessarily distract from the gist of the present disclosure, such explanation, which would be obvious to those skilled in the art, has been omitted.

The accompanying drawings are used only to help easily understand the technical idea of the present disclosure, and it should be understood that the idea of the present disclosure is not limited by the accompanying drawings. The idea of the present disclosure should be construed to encompass any alterations, equivalents and substitutes beyond what is shown in the accompanying drawings.

It will be understood that, although the terms first, second, etc. may be used herein to describe various components, these components should not be limited by these terms. The above terms are used only for the purpose of distinguishing one component from other components, and in particular, should not be construed as determining an order among the components based on the name alone.

Furthermore, the criteria for the terms “upper/above” or “lower/under” is, in principle, used merely to indicate the relative positional relationship between components based on the figure shown in the drawings for convenience, unless it is naturally determined from the nature of each of the components or between the same, or unless otherwise expressed in the specification, and may not be construed as limiting the location of the actual components. For example, “B located above A” merely indicates that B is illustrated as being located above A in the drawing, unless otherwise stated or in the case in which B must be located above A due to the nature of A or B. In the actual product, etc., B may be located under A, and B and A may be provided left and right horizontally.

The term “and/or” is used to include any combination of plural subject items. For example, “A and/or B” includes all three cases such as “A”, “B”, and “A and B”.

It will be understood that when an element is referred to as being “connected to” another element, the element may be directly connected to the other element or intervening elements may also be present. In contrast, when an element is referred to as being “directly connected to” another element, there are no intervening elements present.

A singular representation may include a plural representation unless it represents a definitely different meaning from the context.

Terms such as “include” or “has” are used herein and may be understood that they are intended to indicate an existence of several components, functions or steps, included in the specification, and it is also understood that greater or fewer components, functions, or steps may likewise be utilized.

Unless otherwise defined, all terms including technical and scientific terms used herein have the same meanings as those commonly understood by one of ordinary skill in the art to which the present disclosure belongs. It will be further understood that terms, such as those defined in commonly used dictionaries, should be interpreted as including meanings consistent with their meanings in the context of the relevant art and the present disclosure, and are not to be interpreted in an idealized or overly formal sense unless expressly so defined herein.

Furthermore, “unit” or “control unit” is merely a term widely used in naming a controller that outputs a control value or command for a specific function to another component, and does not mean a generic functional unit. For example, each unit or control unit may include an input and output device configured to exchange signals with another controller or sensor to control the function it is responsible for, a memory configured to store an operating system or logic commands, input/output information, etc., and one or more processors configured to perform judgment, calculation, decision, etc. needed in controlling the function it is responsible for.

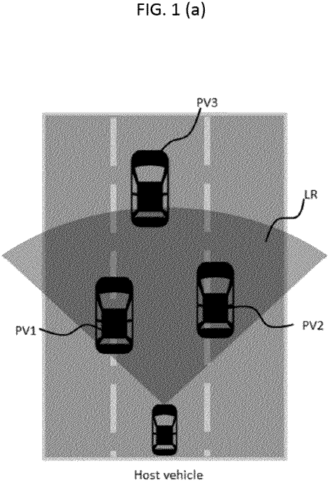

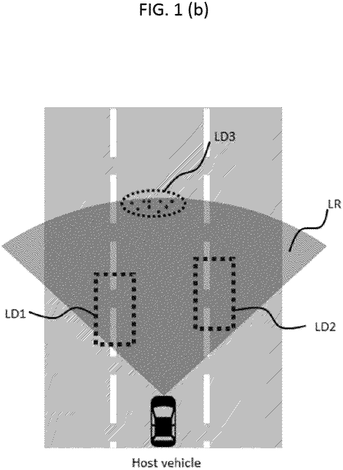

Hereinafter, a method of detecting a stationary obstacle for a vehicle by sensor fusion technology according to various exemplary embodiments of the present disclosure will be described with reference to FIGS. 1 to 7.

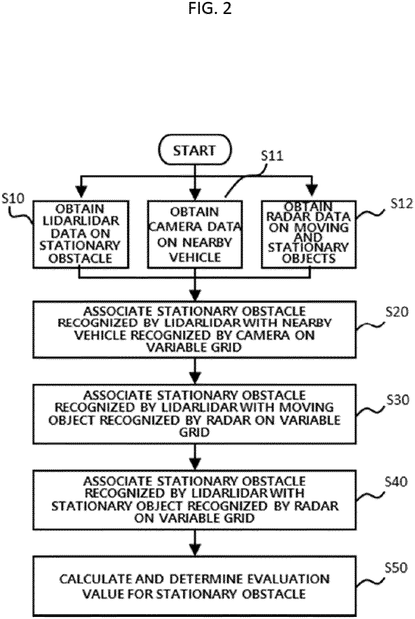

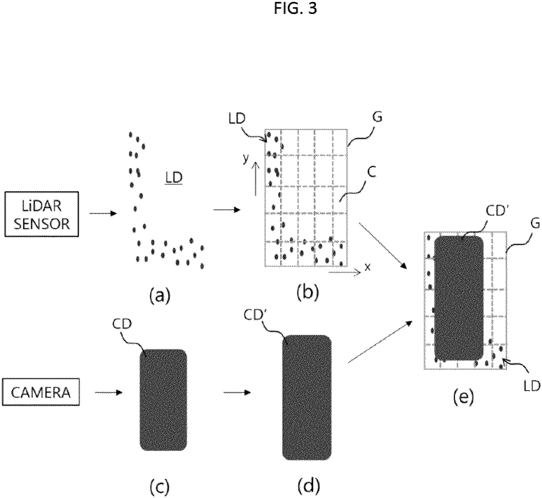

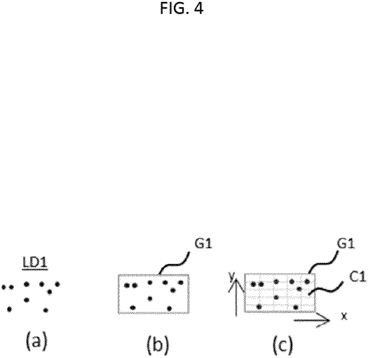

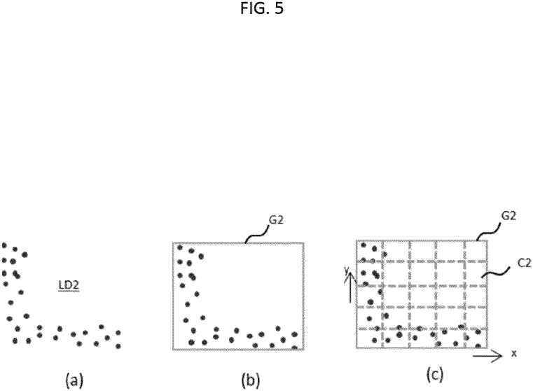

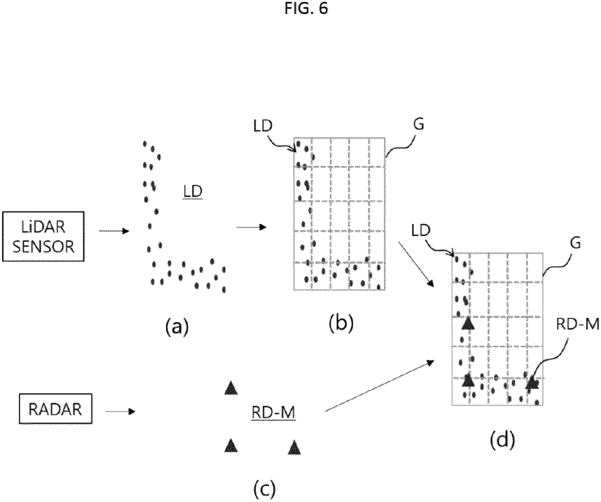

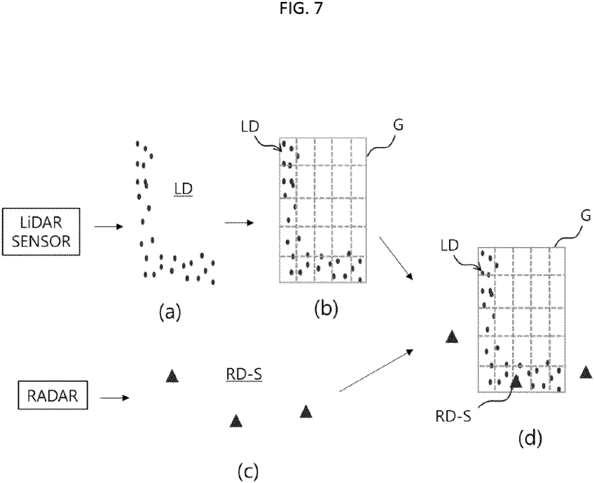

Briefly describing the drawing, FIG. 2 is a flowchart of an obstacle detection method according to various exemplary embodiments of the present disclosure, and FIG. 3 is an example of evaluating the matchability between LiDAR data and camera data. FIG. 4 is an example of a variable grid area and divided cells of LiDAR data for a small object, and FIG. 5 is an example of a variable grid area and divided cells of LiDAR data for a large object. FIG. 6 is an example of evaluating the matchability between LiDAR data and radar data for a moving object, and FIG. 7 is an example of evaluating the matchability between LiDAR data and radar data for a stationary object.

First, a method of detecting an obstacle using LiDAR may be the same as in the related art exemplarily described above. In other words, traveling vehicles and stationary obstacles may be recognized by obtaining LiDAR data on obstacles around a host vehicle, and processing the obtained LiDAR data as in the related art.

Here, the reliability of LiDAR data on the stationary obstacle obtained using the detection method of the exemplary embodiment may be increased by an evaluation process to be described later.

Furthermore, LiDAR data on the stationary obstacle is obtained in step S10, and non-LiDAR data on the nearby obstacle is also obtained by a sensor other than LiDAR in steps S11 and S12.

Non-LiDAR data may include camera data and radar data.

As one of non-LiDAR data, first, camera data on a nearby vehicle may be obtained by data processing such as image processing from camera data on the surrounding environment in step S11.

Furthermore, radar data on a moving object and a stationary object may be obtained from radar data on the surrounding environment in step S12.

When LiDAR data and non-LiDAR data are obtained in steps S10, S11, and S12, the reliability thereof is evaluated by comparing the LiDAR data on the stationary obstacle with the non-LiDAR data. Hereinafter, this will be described in detail.

First, a first evaluation value is determined by evaluating the matchability between the stationary obstacle recognized by the LiDAR and the nearby vehicle recognized by the camera based on the correlation on a variable grid G in step S20.

To the present end, in the exemplary embodiment of the present disclosure, as shown in FIG. 3, a corresponding variable grid area G is set for LiDAR data LD on a stationary obstacle.

Accordingly, the variable grid area G is divided into a plurality of cells C by a predetermined division method.

In the exemplary embodiment of the present disclosure, the variable grid area G has a rectangular shape, and includes five cells C each in a lateral direction x and in a longitudinal direction y. The shape of the grid, the division method, and the number of divisions in the present exemplary embodiment are merely examples, and the present disclosure is not necessarily limited thereto.

Furthermore, in the exemplary embodiment of the present disclosure, the variable grid area G is not fixed, but variable in accordance with the size of a stationary obstacle. Although the size of the grid is variably changed, the number of cells included therein is constant.

Such a variable grid area G may be set based on the minimum and maximum values of the horizontal coordinate x and the minimum and maximum values of the vertical coordinate y of target LiDAR data LD. For example, the grid area G may be set so that all of the LiDAR data LD is located within the grid area G based on the minimum and maximum coordinate values.

The variable grid G will be described in more detail with reference to FIG. 4 and FIG. 5.

First, FIG. 4 is an example of setting of a variable grid area for a small object, and FIG. 5 is an example of setting of a variable grid area for a large object.

A grid area G1 of FIG. 4 is set small according to the minimum and maximum coordinate values of corresponding LiDAR data LD1. Similarly, a grid area G2 of FIG. 5 is set to be relatively large according to the minimum and maximum coordinate values of corresponding LiDAR data LD2.

However, the grid area G is divided into a plurality of cells C by a predetermined division method regardless of the size thereof. For example, the grid area G1 includes 5 cells C1 in the horizontal direction and 5 cells C1 in the vertical direction in FIG. 4. In FIG. 5, although the grid area G2 is greater than the grid area G1, the grid area G2 is divided into 5 cells C2 in the horizontal direction and 5 cells C2 in the vertical direction as in FIG. 4.

Referring back to FIG. 3, camera data on a nearby vehicle may be displayed as a camera data area CD corresponding thereto.

Here, the camera data area CD may be adjusted by an average position error of the camera to obtain an adjusted camera data area CD′.

Next, the adjusted camera data area CD′ is overlapped with the variable grid area G for the stationary obstacle on a matched coordinate to determine the overlap, determining the first evaluation value.

For example, the overlap (or the first evaluation value) may be determined as a ratio of the number of cells C overlapping the camera data area CD to the total number of cells C in the grid area G.

In FIG. 3, the total number of cells C is 25 and the number of cells C overlapping the camera data area CD is 20, so that the overlap (or first evaluation value) may be determined as 0.8.

Because the camera data CD is data extracted from a nearby traveling vehicle, the larger the overlap, the higher the possibility that the corresponding LiDAR data LD is not a stationary obstacle.

Next, a second evaluation value is determined by evaluating the matchability between a stationary obstacle recognized by LiDAR and a moving object recognized by radar based on the correlation on the variable grid G in step S30.

As shown in FIG. 6, similar to the case in FIG. 3, a radar data area RD-M for a moving object is overlapped with the grid area G for the stationary obstacle to determine the overlap, and the second evaluation value is determined accordingly.

Here too, the overlap (or the second evaluation value) may be determined as a ratio of the number of cells C overlapping the radar data area RD-M for a moving object to the total number of cells C in the grid area G.

For example, in FIG. 6, the total number of cells C is 25 and the number of cells C overlapping the radar data area RD-M is 8, so that the overlap (or the second evaluation value) may be determined as 0.32.

Because the radar data RD-M is data extracted from the moving object, the larger the overlap, the higher the possibility that the corresponding LiDAR data LD is not a stationary obstacle.

Next, a third evaluation value is determined by evaluating the matchability between a stationary obstacle recognized by LiDAR and a stationary object recognized by radar based on the correlation on the variable grid G in step S40.

As shown in FIG. 7, here too, by matching the coordinates, a radar data area RD-S for a stationary object is overlapped with the variable grid area G for the stationary obstacle to determine the overlap, and the third evaluation value is determined accordingly.

Similarly, the overlap (or the third evaluation value) may be determined as a ratio of the number of cells C overlapping the radar data area RD-S for a stationary object to the total number of cells C in the grid area G.

For example, in FIG. 7, the total number of cells C is 25 and the number of cells C overlapping the radar data area RD-S is 2, so that the overlap (or the third evaluation value) may be determined as 0.08.

Because the radar data RD-S is data extracted from the stationary object, the larger the overlap, the higher the possibility that the corresponding LiDAR data LD is a stationary obstacle.

A weight factor is added to each of the first, second, and third evaluation values, and is added to a fourth evaluation value of the LiDAR data LD itself on the stationary obstacle, determining the final evaluation value.

Here, a reliability value of the LiDAR data LD may be used as the fourth evaluation value, and be determined as in the method of the related art, so a detailed description thereof will be omitted.

For example, the final evaluation value may be determined as in Equation 1 below.

$${\text{v}}_{\text{f}} = \text{a} ⋅ {\text{v}}_{1} + \text{b} ⋅ {\text{v}}_{2} + \text{c} ⋅ {\text{v}}_{3} + \text{d} ⋅ {\text{v}}_{4}$$

Here, Vf denotes the final evaluation value, V₁ denotes the first evaluation value, V₂ denotes the second evaluation value, V₃ denotes the third evaluation value, and V₄ denotes the fourth evaluation value.

Furthermore, a may be a weight factor for the first evaluation value, b for the second evaluation value, c for the third evaluation value, and d for the fourth evaluation value, a and b being negative numbers, and c being a positive number.

Meanwhile, d may be set to 1, which means that when there is no matching data such as camera data or radar data, it may be evaluated using only LiDAR data LD.

When the final evaluation value is determined, whether the corresponding LiDAR data LD is for a stationary obstacle may be finally determined. For example, when the final evaluation value is greater than or equal to a reference value, the object of the corresponding LiDAR data LD may be determined to be a stationary obstacle.

By the method of the exemplary embodiment of the present disclosure, it may be possible to obtain a result of higher reliability than the conventional method of detecting a stationary obstacle using only LiDAR data LD.

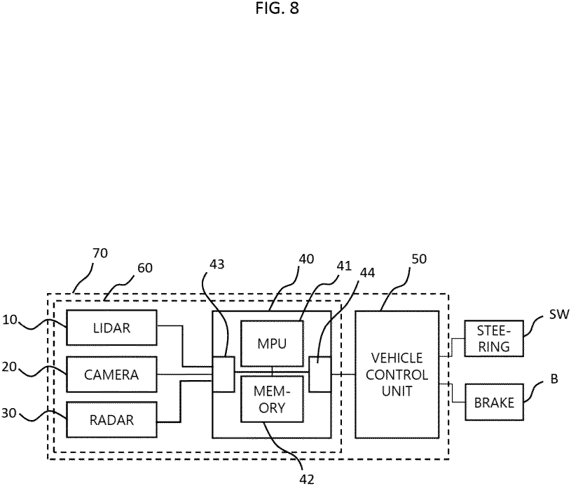

The above-described method of various exemplary embodiments of the present disclosure may be implemented in a stationary obstacle detection system 60 for a vehicle and a vehicle driving system 70, which are mounted in the vehicle. Hereinafter, the stationary obstacle detection system 60 and the vehicle driving system 70 according to various exemplary embodiments of the present disclosure will be described with reference to the conceptual diagram of FIG. 8.

First, in addition to the LiDAR 10, a camera 20 and a radar 30 are included as non-LiDAR sensors. Positions at which the sensors 10, 20, and 30 are provided in the vehicle may be respectively selected according to the optimal performance of each sensor, and do not necessarily have to be the same. However, to fuse two or more sensors, different coordinate systems of each sensor may be moved to one coordinate system and then fused.

For example, after mounting two sensors, which are the camera 20 and the LiDAR 10, at positions configured for achieving optimal performance, respectively, and performing object detection by each of the sensors 10 and 20, the pixel coordinates of the camera 20 are converted into the world coordinates of the LiDAR 10 and the world coordinates of the LiDAR 10 are converted into the pixel coordinates of the camera 20 to fuse the same.

An evaluation determination unit 40 includes an input device 43, an output device 44, a microprocessor 41, a memory 42, and the like.

Data obtained from the LiDAR 10, the camera 20, the radar 30, etc. is input to the evaluation determination unit 40 through the input device 43. Here, pre-processing of data may be performed in the processor of each sensor, such as the LiDAR 10, the camera 20, and the radar 30. For example, the LiDAR data input by the input device 43 may be data extracted only from nearby obstacle data including stationary obstacles, the camera data may be extracted only from nearby vehicles, and the radar data may be data extracted only from moving and stationary objects. Of course, it is natural that data may be input to the evaluation determination unit 40 without such pre-processing.

In the microprocessor 41, the method of the above-described embodiment is input as a program. Therefore, when data is input from each of the sensors 10, 20, and 30, the microprocessor 41 performs evaluation and determination of stationary obstacles using the method of the above-described embodiment in steps S20 to S50.

The memory 42 stores an operating system or logic commands, input/output information, the above-described evaluation value, etc.

The result determined by the evaluation determination unit 40 is transmitted to a vehicle control unit 50 through the output device 44.

Accordingly, the vehicle control unit 50 transmits a control signal for a steering wheel SW and/or a brake B to each corresponding device according to the result, i.e., whether the LiDAR data is determined to be the final stationary obstacle. For example, when the final evaluation value determined by the evaluation determination unit 40 is greater than or equal to the reference value and the object of the LiDAR data is determined to be a stationary obstacle, a steering control signal may be transmitted so that the vehicle changes lanes to avoid a collision or a demand braking torque may be transmitted for deceleration or stopping of the vehicle.

According to various exemplary embodiments of the present disclosure, the reliability of detecting a stationary obstacle using LiDAR may be increased.

In various exemplary embodiments of the present disclosure, the control device may be implemented in a form of hardware or software, or may be implemented in a combination of hardware and software.

Furthermore, the terms such as “unit”, “module”, etc. included in the specification mean units for processing at least one function or operation, which may be implemented by hardware, software, or a combination thereof.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The foregoing descriptions of predetermined exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described to explain certain principles of the present disclosure and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A stationary obstacle detection method for a vehicle by sensor fusion, the method comprising:
collecting, by a processor, Light Detection and Ranging (LiDAR) data on a surrounding area of the vehicle;
collecting, by the processor, at least one of non-LiDAR data of camera data and radar data on the surrounding area of the vehicle;
extracting, by the processor, a stationary obstacle candidate from the LiDAR data;
extracting, by the processor, matching data to be matched with the extracted stationary obstacle candidate from the non-LiDAR data; and
evaluating, by the processor, matchability between the LiDAR data on the extracted stationary obstacle candidate and the matching data on a variable grid to determine whether the extracted stationary obstacle candidate is a stationary obstacle.

2. The method of claim 1, wherein the evaluating includes:
generating the variable grid corresponding to the LiDAR data on the extracted stationary obstacle candidate and setting a matching data area corresponding to the matching data on the variable grid; and
determining an evaluation value according to an overlap between a variable grid area and the matching data area.

3. The method of claim 2, wherein the overlap is determined by a ratio of a number of cells overlapping the matching data area to a total number of cells in the variable grid area.

4. The method of claim 3, wherein the variable grid includes a constant number of cells regardless of sizes of the stationary obstacle candidate and the matching data.

5. The method of claim 3,
wherein the variable grid has a rectangular shape, and
wherein the cells in the variable grid area are divided into m cells in a horizontal direction and n cells in a longitudinal direction in the variable grid area, wherein the m and the n are integers greater than zero.

6. The method of claim 2, wherein the variable grid is determined by maximum and minimum values in a horizontal direction and maximum and minimum values in a longitudinal direction in the LiDAR data on the extracted stationary obstacle candidate.

7. The method of claim 2, wherein the matching data includes at least one of camera data on a moving object, radar data on the moving object, and radar data on a stationary object.

8. The method of claim 7, wherein the evaluation value is determined according to at least one of:
a first evaluation value determined from a first overlap between an area corresponding to the camera data on the moving object and the variable grid area,
a second evaluation value determined from a second overlap between an area corresponding to the radar data on the moving object and the variable grid area,
a third evaluation value determined from a third overlap between an area corresponding to the radar data on the stationary object and the variable grid area, and
a fourth evaluation value for the LiDAR data on the extracted stationary obstacle candidate itself.

9. The method of claim 8, wherein the evaluation value is determined by adding a weight factor to each of the first evaluation value, the second evaluation value, the third evaluation value, and the fourth evaluation value.

10. The method of claim 8, wherein a final evaluation value (Vf) is determined by a following equation:
$${\text{v}}_{\text{f}} = \text{a} ⋅ {\text{v}}_{1} + \text{b} ⋅ {\text{v}}_{2} + \text{c} ⋅ {\text{v}}_{3} + \text{d} ⋅ {\text{v}}_{4}$$
wherein V₁ denotes the first evaluation value, V₂ denotes the second evaluation value, V₃ denotes the third evaluation value, and V₄ denotes the fourth evaluation value, and
wherein a is a first weight factor for the first evaluation value, b is a second weight factor for the second evaluation value, c is a third weight factor for the third evaluation value, and d is a fourth weight factor for the fourth evaluation value.

11. The method of claim 10, wherein when the final evaluation value is greater than or equal to a reference value, the processor is configured to generate a steering control signal so that the vehicle changes lanes to avoid a collision or to generate a demand braking torque for deceleration or stopping of the vehicle.

12. The method of claim 8, wherein the area corresponding to the camera data on the moving object is adjusted in size in consideration of a location of a camera.

13. The method of claim 8, wherein the first evaluation value is set smaller as the first overlap increases.

14. The method of claim 8, wherein the second evaluation value is set smaller as the second overlap increases.

15. The method of claim 8, wherein the third evaluation value is set smaller as the third overlap increases.

16. A stationary obstacle detection system for a vehicle using sensor fusion technology, the stationary obstacle detection system comprising:
a Light Detection and Ranging (LiDAR) sensor configured to obtain LiDAR data on a surrounding area of the vehicle;
a non-LiDAR sensor configured to collect at least one of non-LiDAR data from camera data and radar data on the surrounding area of the vehicle; and
an evaluation determination unit configured to extract a stationary obstacle candidate from the LiDAR data, extract matching data to be matched with the extracted stationary obstacle candidate from the non-LiDAR data, and determine whether the extracted stationary obstacle candidate is a stationary obstacle by evaluating matchability between the LiDAR data on the extracted stationary obstacle candidate and the matching data on a variable grid.

17. The stationary obstacle detection system of claim 16, wherein in the evaluating, the evaluation determination unit is configured for:
generating the variable grid corresponding to the LiDAR data on the extracted stationary obstacle candidate and setting a matching data area corresponding to the matching data on the variable grid; and
determining an evaluation value according to an overlap between a variable grid area and the matching data area.

18. The stationary obstacle detection system of claim 17,
wherein the matching data includes at least one of camera data on a moving object, radar data on the moving object, and radar data on a stationary object, and
wherein the evaluation value is determined according to at least one of:
a first evaluation value determined from a first overlap between an area corresponding to the camera data on the moving object and the variable grid area,
a second evaluation value determined from a second overlap between an area corresponding to the radar data on the moving object and the variable grid area,
a third evaluation value determined from a third overlap between an area corresponding to the radar data on the stationary object and the variable grid area, and
a fourth evaluation value for the LiDAR data on the extracted stationary obstacle candidate itself.

19. The stationary obstacle detection system of claim 18, wherein a final evaluation value (Vf) is determined by a following equation:
$${\text{v}}_{\text{f}} = \text{a} ⋅ {\text{v}}_{1} + \text{b} ⋅ {\text{v}}_{2} + \text{c} ⋅ {\text{v}}_{3} + \text{d} ⋅ {\text{v}}_{4}$$
wherein V₁ denotes the first evaluation value, V₂ denotes the second evaluation value, V₃ denotes the third evaluation value, and V₄ denotes the fourth evaluation value, and
wherein a is a first weight factor for the first evaluation value, b is a second weight factor for the second evaluation value, c is a third weight factor for the third evaluation value, and d is a fourth weight factor for the fourth evaluation value, and
wherein when the evaluation determination unit concludes that the final evaluation value is greater than or equal to a reference value, a vehicle control unit is configured to output a control signal.

20. A vehicle driving system comprising:
the stationary obstacle detection system of claim 16, and
a vehicle control unit configured to output a control signal for a brake and/or a steering apparatus according to a determination of the evaluation determination unit.
